(19) United States
(12) Patent Application Publication
(10) Pub. No.: US 2026/0351739 A1
(43) Pub. Date: Nov. 5, 2026

(54) FIBER PLASTIC COMPOSITE FOR BATTERY HOUSING

(71) Applicant: BOND-LAMINATES GMBH, BRILON (DE)

(72) Inventors: Stefan SEIDEL, BRILON (DE); Philipp GENDERS, BRILON (DE); Simon RÖSEN, BRILON (DE); Klaus VONBERG, BRILON (DE)

(21) Appl. No.: 19/485,518

(22) PCT Filed: May 17, 2024
(86) PCT No.: PCT/EP2024/063726

§ 371 Date: Nov. 18, 2025

(30) Foreign Application Priority Data
May 19, 2023 (EP) 23174209.9

(51) Int. Cl. H01M 50/122; H01M 50/117; H01M 50/121; H01M 50/126; H01M 50/133

(52) U.S. Cl. CPC H01M 50/122; H01M 50/117; H01M 50/121; H01M 50/126; H01M 50/133

(57) ABSTRACT

The present invention relates to a multilayer fibrous plastic composite (10) comprising at least three layers, said three layers comprising a core layer (12), a first outer layer (14) and a second outer layer (16), said core layer being disposed between said first outer layer and said second outer layer, wherein said core layer, said first outer layer and said second outer layer each comprise a textile fiber material in a matrix material comprising a plastic, wherein the fiber material of at least the first outer layer and the second outer layer is preferably electrically insulating, wherein the first outer layer and the second outer layer comprise less air inclusions compared to the core layer, wherein the most outer layers have a closed plastic surface to the outside, and such a composite has beneficial properties especially when used for forming a battery housing.

The present invention relates to a fiber plastic composite. The present invention further relates to a battery housing comprising such a composite.

Materials with special properties are needed for applications in the field of electromobility, especially in the area of batteries and battery housings. They should be as light as possible, i.e. have a low density, in order to increase the range of the vehicle. They also require high stiffness and strength to protect the battery from mechanical damage, and high surface resistance is needed to prevent short circuits, electrical flashover or other electrical damage. Finally, the enclosure should provide fire protection, both to prevent flames from reaching the battery from the outside and to protect the vehicle's occupants if there is a catastrophic fire in the battery itself, a so-called thermal runaway, in which a chain reaction can result in a cascading release of extremely high energies.

EP 3 330 081 B1 describes a composite panel composed of a fiber-reinforced resin matrix composite material, the composite panel comprising: a multilayer laminate including: a front layer comprising a resin and a filler material having a lower coefficient of thermal expansion than the resin of the front layer; a middle multilayered portion comprising a plurality of middle layers of fiber-reinforced resin matrix composite material, at least one of the middle layers comprising a first fiber layer of a plurality of non-woven carbon fibers oriented substantially randomly, the front layer being adjacent to the first fiber layer; and a back reinforcing layer integrally formed with the middle multilayer member and located on a back surface of the multilayer laminate opposite the front layer, the reinforcing layer consisting of a back ply of fiber-reinforced resin matrix composite material, the back ply including a second fiber layer of a plurality of continuous fibers extending continuously from at least a portion of a first edge of the back ply to at least a portion of an opposite second edge of the back ply.

EP 3 552 814 A1 describes fiber-reinforced composites containing and/or partially formed from fibrous nonwoven layers. For example, at least one of the nonwoven layer(s) includes: (1) a first thermoplastic material that may be in the form of a first set of resin fibers; (2) a second thermoplastic material that may be in the form of a second set of resin fibers, the second thermoplastic material having a transition temperature and/or a low shear viscosity that is higher than that of the first thermoplastic material; (3) a first set of reinforcing fibers; and/or (4) a second set of reinforcing fibers of a type that is different from that of the first set of reinforcing fibers.

However, the solutions of the prior art still show potential for improvement.

It is the object of the present invention to overcome, at least in part, one disadvantage of the prior art. In particular, it is the object of the present invention to provide an improved material which shows at least one, in particular all of, of high strength, light weight and good processability.

This object is solved at least in part by a composite as disclosed herein.

In a first aspect there is provided a multilayer fibrous plastic composite comprising at least three layers. The three layers comprise a core layer, a first outer layer and a second outer layer. The core layer is disposed between said first outer layer and said second outer layer. Said core layer, said first outer layer, and said second outer layer each comprise a textile fiber material in a thermoplastic matrix material comprising a plastic.

This object is further solved by a use having the features of as disclosed herein and by a battery housing having the features as disclosed herein.

According to a second aspect there is provided a use of a composite for manufacturing at least a part of a battery housing, wherein c the composite is formed as a multilayer fibrous plastic composite as disclosed herein.

According to a third aspect there is provided a battery housing comprising a composite, wherein the composite is formed as the multilayer fibrous plastic composite as disclosed herein.

Preferred embodiments of the invention are described in the dependent claims, in the description or in the FIGURE, wherein further features described or shown in the dependent claims or in the description or in the FIGURE may individually or in any combination constitute an object of the invention, unless the opposite clearly follows from the context.

Described is a multilayer fibrous plastic composite comprising at least three layers, said three layers comprising a core layer, a first outer layer and a second outer layer, said core layer being disposed between said first outer layer and said second outer layer, wherein said core layer, said first outer layer and said second outer layer each comprise a textile fiber material in a matrix material comprising a plastic, wherein the fiber material of at least the first outer layer and the second outer layer preferably is electrically insulating, wherein the first outer layer and the second outer layer have a higher degree of consolidation compared to the core layer, and wherein the most outer layers have a closed plastic surface to the outside.

Such a composite may show significant improvements over solutions of the prior art especially when used as a housing or a part of the housing of a battery cell, but in no way restricted thereto.

Described is thus a multilayer fibrous plastic composite. The composite thus has a multilayer structure and comprises at least three layers as outlined below.

The at least three layers comprise a core layer, a first outer layer and a second outer layer, said core layer being disposed between said first outer layer and that said second outer layer. Thus, the expression outer layer refers to the position of these layers with regard to the core layer but does not strictly mean that the outer layers are the most outer layers but these may also be covered by one or more further layers.

With regard to the named layers, it is provided that said core layer, said first outer layer and said second outer layer each comprise a textile fiber material in a matrix material comprising a plastic. Therefore, there may be a matrix material in each of the layers, wherein the matrix material of the layers may be different or it may be the same. Generally, the matrix material may be a plastic which might be freely chosen. However, electrically insulating plastics are preferred. Fibers are provided within the matrix material of the core layer, the first outer layer and the second outer layer, wherein the fibers are provided as a textile material.

The specific fibers, i.e. their material as well as their general arrangement in a textile form may be chosen according to the specific needs. However, it is provided that the fiber material of at least the first outer layer and the second outer layer is electrically insulating.

In the sense of the present invention, electrically insulating shall mean an electrical resistivity in the range of equal or more than 1.0E+5 Ω·cm, measured at 20 °C, for example by means of the 4-point and the ring electrode measuring method.

In order to increase the electric resistivity of the composite as a whole, the most outer layers, and thus for example the first outer layer and the second outer layer if these are the most outer layers, have a closed plastic surface to the outside. Thus, when considering the outer surface of the composite, no fibers are present but only the matrix material and thus the particularly electrically insulating plastic is present at the outside.

Regarding the arrangement of the fibers in the matrix material it is further provided that the first outer layer and the second outer layer have a higher degree of consolidation compared to the core layer. Consolidation in the sense of the present invention particularly means the direct contact between the fibers and the matrix material. Therefore, a higher degree of consolidation means a better and closer contact and consequently less air inclusions. The outer layers thus comprise less air inclusions compared to the core layer. In the context of the present invention determination of the proportion of air inclusions (also referred to as void content) of a fibre composite material ply or of the multi layer composite material as disclosed herein was carried out according to the thickness difference method. This comprises determining the layer thickness difference between a theoretical component thickness and the actual component thickness for known basic weights and densities of the plastic and fiber. For the theoretical component thickness complete wetting of the fibers with the polymer matrix (and accordingly no voids) is taken. Relating the thickness difference to the actual component thickness affords the percentage void content (vol %). Measurement of the thickness can preferably be carried out with an outside micrometer. For this method, error-minimized results may preferably be determined by determining the void content on components composed of a plurality of fibre composite material plies, preferably more than 4 fibre composite material plies, particularly preferably more then 6 fibre composite material plies and very particularly preferably 8 fibre composite plies.

Such a composite as described above shows very beneficial properties.

In fact, the composite shows a very good mechanical stability which is important for different applications. The composite may thus withstand high mechanical loads without the risk of a failure.

In particular, the composite as described shows a very high mechanical resistance and stability. The high resistance of the composite may inter alia be based on the specific consolidation of the respective fibers in the layer structure. Apart from that, the stability may be improved by the provision of a textile fiber structure with which its matrix is reinforced.

Such a textile fiber structure may in particular be realized by providing fibers having a length of at least 10 mm, which may also be called endless fibers. Especially such a fiber structure may contribute to the advantageous properties.

This high stability may thereby be reached even in case the composite is formed very thin such as for example in the range of ≤3 mm. Therefore, the composite may be arranged with very low weight. This may allow the range of applications to be increased even further. Especially, the composite according to the invention may be very beneficial if used in mobile applications, such as in vehicles for example in electrically driven or hybrid vehicles.

The present invention thus provides a lightweight alternative to steel and aluminum which is suitable in different applications, such as in the manufacture of battery housings.

The composite may also very well be processed to respective parts, such as to housings of a battery, or battery cell, respectively. For example, the composite may be formed by injection molding and may thus be inserted into a mold and may be overmolded to serve as the base of very flat housings. It was shown that this allows the injection pressure to be reduced by around two-thirds compared with a pure injection-molded part. This in turn enables the use of smaller, less expensive injection molding machines with significantly lower clamping forces. At the same time, wall thicknesses can be greatly reduced, which might also be the case due to the excellent mechanical performance of the composite according to the invention. Overall, this approach results in very competitive manufacturing costs for different applications, such as for battery housings.

It will be appreciated the composite as disclosed herein can be considered as a consolidated stack comprised of multiple layers. It will be further appreciated that in some embodiments the composite can be understood as being provided as a substantially planar sheet material. Advantageously, the sheet material can be lightweight (as compared to metal alternatives and/or fully consolidated variations. In addition, the composite can have a thickness ≤3 mm, e.g. between 0.25 mm and 3 mm. the sheet material can be thermoformed into a desired shape, e.g. by press molding, vacuum molding or other thermoforming means known in the art.

Preferably, the core layer comprises air inclusions in an amount of at least 5% by volume. It was shown that especially this feature allows an improved stability. Especially, this feature allows a high mechanical resistance against an impact of parts hitting the surface of the composite with a very low risk of a damage. A practical upper volumetric content of air inclusions (voids) was determined at about 50 vol %. Preferably the proportion of air inclusions (voids) ≤30 limit. Inventors find that air inclusions above 30 vol %, in particular above 50 vol % increasingly negatively affect one or more of structural integrity and handleability especially during manufacturing. In an exemplary embodiment, the core layer comprises air inclusions in an amount of 5% by volume up to 20% by volume.

Mechanical stability might also be increased in case the fiber material of the first outer layer and of the second outer layer is formed as a woven, scrim or nonwoven fabric.

Especially, this feature contributes to a high mechanical stability against external influences. With regard to the specific arrangement of the fibers, the arrangement of the first outer layer and the second outer layer may be the same or it may be different.

Further preferred, the first outer layer and the second outer layer comprise glass fibers. Such a material may have a very high electrical resistance so that it is very suitable as an electrically insulating material. Apart from that, it was shown that especially glass fibre reinforced composite materials show a very high stability at a very small weight. Glass fibers may further very well be processed into textile structures, so that very defined fiber structures may be reached. This in turn allows providing a textile material and thus a composite having well-defined properties.

It may further be preferred that the fiber material of the core layer is selected from carbon fibers, aramid fibers, basalt fibers and glass fibers. Like said with regard to the outer layers, such fibers may combine a very well processability with a high strength and a small weight.

Therefore, these fibers have superb properties for a composite according to the present invention.

For example, in case glass fibers, aramid fibers, basalt fibers are used, as such fibers are electrically insulating, the whole composite may for example consist of electrically insulating materials. This in turn may be very beneficial for a plurality of applications, such as for battery housings as non-restricting examples.

On the other side, for example in case carbon fibers are used, the composite may provide electrical shielding. In detail, shielding of electromagnetic frequencies between 30 and 2000 MHz of up to 100 dB can be achieved, which is comparable to aluminum. Therefore, a mechanically very stable part is formed by the composite of the present invention which provides an additional functionality, which also is very advantageous for a plurality of applications, such as for battery housings as non-restricting examples.

To retain electrical insulating properties across a thickness of the stack of layers, e.g. one core layer sandwiched between two outer layers, it is preferred that at least one of the core layer and outer layers is an electrically insulating layer, e.g. by consisting of electrically insulating material. In a preferred variation at least one of the layers (e.g. the core layer) is an electrically insulating layer and at least one of the layers (e.g. an outer layer) is electrically conductive, e.g. by comprising electrically conductive fibrous material and/or an electrically conductive matrix material. Providing a stack wherein at least one of the layers in an electrically insulating layer and at least one layer is electrically insulating combines benefits as to shielding an insulation. This can be very advantageous for a plurality of applications, such as for battery housings providing combined benefits of shielding the housed contents against external electric fields while insulating external bodies from a direct electrical contact with the housed content.

It may further be preferred that the matrix material of at least one of the core layer, the first outer layer and the second outer layer comprises a material selected from the list consisting of polyolefins, polyamides, polyesters, polycarbonates, thermoplastic elastomers and polyphenylene sulfide. Such materials may also combine well processability with lightweight properties and good electrical insulation properties. Specific examples of the matrix material may comprise polyamide 6, polyamide 66, polypropylene, and polybutylene terephthalate (PBT), wherein polyamide 6, polyamide 66, polypropylene might be preferred.

With regard to the different layers, it may be provided that the matrix material off all layers is the same or that the matrix material of different layers, such as of the outer layers on the one side and of the core layer on the other side may differ.

Another advantage of the composite according to this embodiment may be seen in the fact that the composite may be easily recycled due to its thermoplastic matrix. It therefore lends itself to the establishment of sustainable material cycles.

Further preferred, the fiber material may be present in a proportion of at least 60% by weight, based on the composite material. According to this embodiment, a high stability may be combined in a very preferred manner with a good processability, especially for forming parts by means of molding like described above. Exemplarily, the fiber material may be present in a proportion of 60% by weight to 90% by weight, based on the composite material.

It may further be preferred that a plurality of at least three core layers is provided. In other words, it may be beneficial that between the first and the second outer layer, there may be provided a plurality of more than two core layers. The core layers be each be defined by a distinct textile fibre structure which is embedded in matrix material. The respective core layers may be separated by layers of pure matrix material. It may further be provided that the core layers are the same or different. The core layers may comprise a combination of the previously mentioned materials, i.e. glass, carbon, basalt, aramid, each as woven, scrim or nonwoven or preferably as a needled web. In an especially preferred embodiment, the same fiber material is used for all core layers.

Further preferably, the composite material has a symmetrical structure with respect to its layer sequence. Such a symmetrical arrangement allows very defined properties to occur, both from the inside as well as from the outside, in case the composite is used as a housing for example. Thus, the composite has a high stability against influences from the inside and the outside.

It may further be preferred that the fiber composite material has a CTI (Comparative Tracking Index) value of at least 400V. This embodiment may be especially beneficial in case the composite is used in electrical applications, such as for example in battery systems. As an example, the composite may be used as a housing for a battery cell. Especially according to this embodiment, it can be secured that even in case the housing comes into contact with an electrically conductive part, no negative influence will occur due to the very good insulating properties. The CTI value may inter alia be determined via DIN EN 60112:2010. The CTI is used to measure the electrical breakdown (tracking) properties of insulating materials. Tracking is an electrical breakdown on the surface of an insulating material wherein an initial exposure to electrical arcing heat carbonizes the material. The carbonized areas are more conductive than the pristine insulator, increasing current flow, resulting in increased heat generation, and eventually the insulation becomes completely conductive. Inventors find that the CTI is usually dominated by the properties of the reinforcement fiber. Glass as well as other electrically insulating fibers, were found to enable appropriately high CTI values. In contrast, carbon fibers (electrically conductive) were found to reduce the CTI significantly. The polymer was found to have a comparatively smaller influence (PP insulates better than PC for example).

It may further be preferred that the fiber composite material has a plurality of core layers comprising a needled web of carbon fibers, wherein the first outer layer and the second outer layer each comprise glass fibers. Especially this embodiment shows an outstanding stability especially against parts acting onto the composite from the outside and/or inside, thereby showing very low flammability under additional mechanical loads. Therefore, the composite according to this embodiment shows outstanding properties especially in case it is used as a housing for potentially dangerous components, such as battery cells.

The latter is also the case if the fiber composite material has a plurality of core layers comprising a needled web of glass fibers, aramid fibers, and basalt fibers, the first outer layer and the second outer layer each having a fabric comprising glass fibers.

With regard to further advantages and technical features of the composite, reference is made to the explanations of use, the battery housing, the FIGURE and the description of the FIGURE.

Further described is the use of a composite for manufacturing at least a part of a battery housing, wherein the composite is formed as a multilayer fibrous plastic composite as described before.

It could be shown that especially with regard to using the described composite for a housing of a battery cell, for example of a battery cell, outstanding properties may be reached.

With regard to battery cells, electrical malfunctions or mechanical damage may lead to a fire in the cells. Temperatures of well over 1,000 °C, very high pressures due to escaping gases and directed flames with glowing particles from the cell cathode and anode, for example, may occur. Therefore, housings of battery cells should withstand high pressure, high temperatures as well as the impact of parts acting on the composite with high speed. This so-called thermal runaway process must be secured as well as possible. That's why it's important for battery housing materials to withstand the exceptional conditions to prevent the entire vehicle from catching fire, or at least to give occupants enough time to get to safety. The composite material according to the invention passes the rigorous thermal runaway tests currently on the market, which replicate these extreme loads, at test specimen thicknesses of equal or less than three millimeters. On the other side, battery housings should protect the battery cells from external influences.

In particular, such a fiber composite can withstand the conditions of a thermal runaway, since the not fully impregnated core of non-combustible fibers absorbs the thermal and abrasive loads of the thermal runaway at high temperatures.

Especially in case the composite when used as a battery housing or at least a part thereof is formed in a thickness of ≤3 mm, actual requirements may be met. For example, the composite may have a thickness in the range of ≤2.5 mm. A minimum thickness depends on a number of layers comprised in the core and each of the outer layers. A minimum total thickness of a consolidated product be as low as 0.25 mm. It is thus a lightweight alternative to steel and aluminum, for example, in the manufacture of battery housings.

Apart from the above-described mechanical advantages, the composite according to the invention may well withstand immersion in cooling fluids, such as dielectric coolants and water-glycol coolant mixtures. These electrically non-conductive and flame-retardant fluids are often used to flood entire battery housings for direct cooling (immersion cooling). Tests showed that even after more than 1,500 hours of storage, the composite, such as having polyamide 6, polyamide 66 and polypropylene compounds as matrix material, did not change their mechanical properties, nor did they swell or lose their flame retardancy. They can therefore be used without problems in the dielectric fluids.

It is further important to note that large-format battery housings can also be economically injection molded using, among other things, large inserts made of the composite. This means that, in addition to impact extrusion, another process is available for manufacturing these highly complex and highly stressed safety components from thermoplastics.

With regard to further advantages and technical features of the use, reference is made to the explanations of the composite, the battery housing, the FIGURE and the description of the FIGURE.

Further described is a battery housing comprising a composite, wherein the composite is formed like described above.

As indicated above, especially the use of the described composite for a battery housing, such as for a housing for a battery cell, may be very beneficial. In fact, a very high mechanical stability may be combined with very good electrical insulation properties, so that the housing may be stable even in case of dramatic failures, such as a so-called thermal runaway.

With regard to further advantages and technical features of the battery housing, reference is made to the explanations of the composite, the use, the FIGURE and the description of the FIGURE.

A process for producing a fibre composite material ply of the thermoplastic-based multilayer composite material according to the invention can be realized using commercially available raw material. The process in particular comprises the following steps of (i) providing a textile semi-finished product and conveying this textile semi-finished product along a processing path, (ii) applying the plastic, e.g. a polycarbonate, polyamide or other thermoplastic polymer, over at least part of a width, of the textile semi-finished product, preferably its entire width, (iii) combining the required number of plastic-treated textile semifinished products in superposed form and simultaneously conveying along a common processing path, (iv) applying a pressure to the superposed, plastic-treated textile semifinished products perpendicular to the plane of the textile semifinished products, wherein the application of pressure with at least one compression ram coupled with simultaneous temperature-elevation of the compression ram with a longitudinal motion component in the belt plane and perpendicular to a textile semifinished product ply running direction is carried out using a static heated press, preferably using a heatable interval press or heatable double-belt press, (v) simultaneously holding the multi-ply construction of the plastic-treated textile semifinished product plies in a processing temperature range above the glass transition temperature of the plastic to be employed, and (vi) reducing the processing temperature range, preferably before the application of pressure is terminated.

The use of interval heating presses, also occasionally known as interval hot presses, in the production of composites is known to those skilled in the art from EP3257893 A1. Double-belt presses are known to those skilled in the art from EP 0131879 A1.

Polymer application of plastic, preferably thermoplasts such as polycarbonate or polyamide, with subsequent application of pressure/temperature results in effective incorporation of the plastic melt into the fibre volume structure of the textile semifinished product provided that the pressure is combined with a temperature above the glass transition temperature of the employed plastic. The amount of pore volume (air inclusions) in the formed composite (as determinable after cooling) can be regulated by varying the amount of matrix material per unit volume of reinforcement material For example by setting and/or adjusting a proportion of polymer applied per reinforcement material in dependence of a desired and/or determined pore content.

The invention is further explained below with reference to the FIGURE and an example of an embodiment.

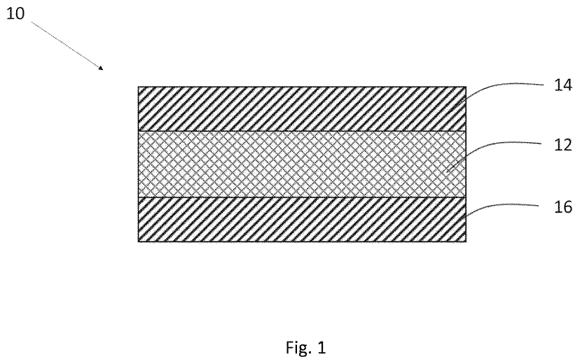

FIG. 1 schematically shows an embodiment of a composite according to the present invention.

In FIG. 1, a composite 10 according to the invention is shown, which is suitable for manufacturing at least a part of a battery housing. For example, the composite 10 may form a battery cover. The composite may thus be used for at least in part enclosing a battery cell. With this regard, it may have a thickness of equal or less than 3 mm.

The composite 10 is a multilayer fibrous plastic composite 10 comprising at least three layers, said three layers comprising a core layer 12, a first outer layer 14 and a second outer layer 16. The core layer 12 is disposed between said first outer layer 14 and said second outer layer 16. Said core layer 12, said first outer layer 14 and said second outer layer 16 each comprise a textile fiber material in a matrix material comprising a plastic, wherein the fiber material of at least the first outer layer 14 and the second outer layer 16 preferably is electrically insulating. The fiber material is present in a proportion of at least 60% by weight, based on the composite material.

In more detail and with regard to the provided fibers, the fiber material of the core layer 12 is selected from carbon fibers, aramid fibers, basalt fibers and glass fibers and is preferably formed as a needled web. Further, the fiber material of the first outer layer 14 and of the second outer layer 16 is formed as a woven, scrim or nonwoven fabric and is particularly formed of glass fibers.

Regarding the matrix material, the latter of at least one of the core layer 12, the first outer layer 14 and the second outer layer 16 comprises a material selected from the list consisting of polyolefins, polyamides, polyesters, polycarbonates, thermoplastic elastomers and polyphenylene sulfide. Generally, it might be preferred that the matrix material of all layers is the same.

It might be preferred that a plurality of at least three core layers 12 is provided, each being disposed between the first outer layer 14 and the second outer layer 16. According to a preferred embodiment, the composite has a plurality of core layers comprising a needled web of glass fibers, aramid fibers, and basalt fibers, wherein the first outer layer and the second outer layer each comprise glass fibers. Alternatively, the composite has a plurality of core layers comprising a needled web of glass fibers, wherein the first outer layer and the second outer layer each comprise glass fibers.

According to an especially preferred embodiment, both outer layers 14, 16 and core layers 12 are made from a glass fiber textile, wherein five or six core layers 12 may be present. Alternatively, the outer layer glass 14, 16 may comprise a glass fiber textile, wherein the core layer 12 comprises four layers of needled web of carbon fibers.

It is further provided that the first outer layer 14 and the second outer layer 16 have a higher degree of consolidation compared to the core layer 12. In particular, the core layer 12 comprises air inclusions in an amount of at least 5% by volume.

Further, the most outer layers, such as the first outer layer 14 and the second outer layer 16 according to FIG. 1, have a closed plastic surface to the outside. It may thus be reached that the fiber composite material has a CTI value of at least 400V.

FIG. 1 further shows that the composite material has a symmetrical structure with respect to its layer sequence.

The application further relates to the following embodiments.

In a first embodiment there is provided a multilayer fibrous plastic composite (10) comprising at least three layers, said three layers comprising a core layer (12), a first outer layer (14) and a second outer layer (16), said core layer (12) being disposed between said first outer layer (14) and said second outer layer (16), wherein said core layer (12), said first outer layer (14) and said second outer layer (16) each comprise a textile fiber material in a matrix material comprising a plastic, wherein the fiber material of at least the first outer layer (14) and the second outer layer (16) is preferably electrically insulating, wherein the first outer layer (14) and the second outer layer (16) have a higher degree of consolidation compared to the core layer (12), and wherein the most outer layers have a closed plastic surface to the outside.

In a second embodiment the composite (10) is according to embodiment 1, characterized in that the core layer comprises (12) air inclusions in an amount of at least 5% by volume.

In a third embodiment the Composite (10) is according to one of embodiment 1 or 2, characterized in that the fiber material of the first outer layer (14) and of the second outer layer (16) is formed as a woven, scrim or nonwoven fabric and that the fiber material of the core layer (12) is formed as a needled web.

In a fourth embodiment the Composite (10) is according to any one of embodiment 1 to 3, characterized in that the first outer layer (14) and the second outer layer (16) comprise glass fibers.

In a fifth embodiment the Composite (10) is according to any one of embodiment 1 to 4, characterized in that the fiber material of the core layer (12) is selected from carbon fibers, aramid fibers, basalt fibers and glass fibers.

In a sixth embodiment the Composite (10) is according to any one of embodiment 1 to 5, characterized in that the matrix material of at least one of the core layer (12), the first outer layer (14) and the second outer layer (16) comprises a material selected from the list consisting of polyolefins, polyamides, polyesters, polycarbonates, thermoplastic elastomers and polyphenylene sulfide.

In a seventh embodiment the Composite (10) is according to any one of embodiment 1 to 6, characterized in that the fiber material is present in a proportion of at least 60% by weight, based on the composite material.

In an eight embodiment the Composite (10) is according to any one of embodiment 1 to 7, characterized in that a plurality of at least three core layers (12) is provided.

In a ninth embodiment the Composite (10) is according to any one of embodiment 1 to 8, characterized in that the composite (10) has a symmetrical structure with respect to its layer sequence.

In a tenth embodiment the Composite (10) is according to any one of embodiment 1 to 9, characterized in that the composite (10) has a CTI value of at least 400V.

In an eleventh embodiment the Composite (10) is according to any one of embodiment 1 to 10, characterized in that the composite (10) has a plurality of core layers (12) comprising a needled web of a material selected from carbon fibers, wherein the first outer layer (14) and the second outer layer (16) each comprise glass fibers.

In a twelfth embodiment the Composite (10) is according to any one of embodiment 1 to 10, characterized in that the composite has a plurality of core layers (12) comprising a needled web of glass fibers, aramid fibers, and basalt fibers, wherein the first outer layer (14) and the second outer layer (16) each comprise glass fibers.

In a thirteenth embodiment there is provided a Use of a composite (10) for manufacturing at least a part of a battery housing, characterized in that the composite (10) is formed as a multilayer fibrous plastic composite (10) according to any of embodiment 1 to 12.

In a fourteenth embodiment there is provided a Battery housing comprising a composite (10), characterized in that the composite (10) is formed according to any of embodiment 1 to 12.

In a fifteenth embodiment the Battery housing is according to embodiment 14, characterized in that the composite (10) has a thickness in a range of ≤3 mm.

1-17. (canceled)

18. Multilayer fibrous plastic composite (10) comprising at least three layers, said three layers comprising a core layer (12), a first outer layer (14) and a second outer layer (16), said core layer (12) being disposed between said first outer layer (14) and said second outer layer (16), wherein said core layer (12), said first outer layer (14) and said second outer layer (16) comprise a textile fiber material in a thermoplastic matrix material comprising a plastic, wherein the first outer layer (14) and the second outer layer (16) comprise less air inclusions compared to the core layer (12), wherein the most outer layers have a closed plastic surface to the outside, and wherein the core layer comprises (12) air inclusions in an amount of at least 5% by volume.

19. Composite (10) according to claim 18, wherein the composite is provided as a substantially planar thermoformable sheet material, the sheet material preferably having a thickness ≤3 mm.

20. Composite (10) according to claim 18, wherein the fiber material and the matrix of at least the first outer layer (14) and the second outer layer (16) are electrically insulating.

21. Composite (10) according to claim 18, wherein the fiber material of the first outer layer (14) and of the second outer layer (16) is formed as a woven, scrim or nonwoven fabric and that the fiber material of the core layer (12) is formed as a needled web.

22. Composite (10) according to claim 18, wherein the first outer layer (14) and the second outer layer (16) comprise glass fibers.

23. Composite (10) according to claim 18, wherein the fiber material of the core layer (12) is selected from carbon fibers, aramid fibers, basalt fibers and glass fibers.

24. Composite (10) according to claim 18, wherein the matrix material of at least one of the core layer (12), the first outer layer (14) and the second outer layer (16) comprises a material selected from the list consisting of polyolefins, polyamides, polyesters, polycarbonates, thermoplastic elastomers and polyphenylene sulfide.

25. Composite (10) according to claim 18, wherein at least of one of the core layer (12), the first outer layer (14), and the second outer layer (16) is electrically conductive and at least another of the at least of one of the core layer (12), the first outer layer (14), and the second outer layer (16) is electrically insulating.

26. Composite (10) according to claim 18, wherein the fiber material is present in a proportion of at least 60% by weight, based on the composite material.

27. Composite (10) according to claim 18, wherein a plurality of at least three core layers (12) is provided.

28. Composite (10) according to claim 18, wherein the composite (10) has a symmetrical structure with respect to its layer sequence.

29. Composite (10) according to claim 18, wherein the composite (10) has a comparative tracking index (CTI) of at least 400V, as determined by DIN EN 60112:2010.

30. Composite (10) according to claim 18, wherein the composite (10) has a plurality of core layers (12) comprising a needled web of a material selected from carbon fibers, wherein the first outer layer (14) and the second outer layer (16) each comprise glass fibers.

31. Composite (10) according to claim 18, wherein the composite has a plurality of core layers (12) comprising a needled web of glass fibers, aramid fibers, and basalt fibers, wherein the first outer layer (14) and the second outer layer (16) each comprise glass fibers.

32. Use of a composite (10) for manufacturing at least a part of a battery housing, wherein the composite (10) is formed as a multilayer fibrous plastic composite (10) according to claim 18.

33. Battery housing comprising a composite (10), wherein the composite (10) is formed according to claim 18.

34. Battery housing according to claim 31, wherein the composite (10) has a thickness in a range of ≤3 mm.
